(19) United States
(12) Patent Application Publication
(10) Pub. No.: US 2011/0246375 A1
(43) Pub. Date: Oct. 6, 2011

(54) HOME PURCHASE PROGRAM

(75) Inventor: Brent E. Dutton, Charlotte, NC (US)

(73) Assignee: BANK OF AMERICA CORPORATION, Charlotte, NC (US)

(21) Appl. No.: 12/751,611

(22) Filed: Mar. 31, 2010

(51) Int. Cl. G06Q 50/00; G06Q 30/00; G06Q 40/00; G06Q 10/00

(52) U.S. Cl. 705/80; 705/35; 705/306; 705/316

(57) ABSTRACT

Embodiments of the invention provide apparatuses and methods that provide for a housing purchase program in which a seller agrees to sell a home at a reduced price in return for the buyer agreeing to share with the seller some portion of the home's future appreciation. For example, the seller may desire to sell a home at a first price but the potential buyer wants to purchase the home at a lower price. The seller may agree to sell the home at a price lower than that which the seller desires, but only if the buyer agrees to share some portion of the home's future appreciation. In some embodiments, the housing purchase program further includes a mortgagee/investor that, at least temporarily, pays-off or forgives the seller's remaining mortgage principal that is above the sale price if the seller agrees to pay the mortgagee/investor back with any future appreciation in which the seller shares.

### FIELD

In general, embodiments of the invention relate to apparatuses and methods that provide for an innovative asset purchase program.

### BACKGROUND

Whenever there is a surplus of homes on the market and reduced demand, the market price for housing will typically drop. Several times throughout history, the real estate market has also experienced a significant ballooning of housing prices just before a precipitous price drop. This is sometimes referred to as a housing price “bubble.” When the housing prices change so drastically over a short period of time, many people lose significant equity and may even owe more on their home than what they would be able to sell the home for in the depressed market.

When circumstances like this arise, many homeowners will list their homes for sale at a price that is significantly higher than the price that the depressed market would otherwise dictate because the homeowner is not willing to accept less than some minimum price. For example, a homeowner that purchased a home several years ago for $300,000 and has a mortgage with a $270,000 remaining principal balance may not be willing to sell the house for less than $270,000 because the homeowner may not be able to afford to pay the difference between the sale price and the mortgage, not to mention any realtor fees or other costs associated with the sale. If the market is depressed enough, the homeowner may not be able to find a buyer willing to pay $270,000 or more for the home and, as a result, the home will just sit on the market.

Some of these homeowners will eventually walk away from their homes and allow the bank or other mortgagee to foreclose on or short-sale the homes. These actions can negatively impact, if not destroy, the homeowner's credit rating making it difficult for the homeowner to purchase another home. These actions can also put further downward pressure on the housing market. The banks are often willing to sell these homes below market value to sell the home quickly in an attempt to mitigate the costs associated with the banks foreclosing on the home and/or holding onto the home after a foreclosure. This can cause many buyers on the market to search only for deals in the foreclosure and short-sale market, putting further downward pressure on the prices of non-foreclosed homes.

Still other homeowners will be reluctant to even list their homes for sale. These homeowners that would perhaps normally sell their homes and move to other geographic areas or into larger homes, may now try to wait-out the market downturn for fear of selling at the bottom and losing much of the equity that they had built-up in their homes over the years.

These factors and others can result in a stagnant housing market that further drives prices down. The downward spiraling nature of the housing market can prolong the time it takes for the market to bottom-out and can make it difficult for potential buyers to recognize the market bottom. Would-be sellers must either: (1) try to wait-out the depressed market and sell when prices rise again; (2) sell at a price significantly lower than what they are comfortable with or would otherwise be able to sell at; or (3) walk away from their homes and allow the bank to foreclose. Buyers can also be disadvantaged because some of a buyer's most desirable homes may either not be for sale because the seller is afraid to sell during a depressed market or are listed too high when compared to the prices available for foreclosed homes or other homes priced more appropriately for the depressed market.

Systems and methods are needed in circumstances such as these to restore equilibrium in the housing market more quickly. Systems and methods are also needed to provide would-be sellers with options other than foreclosure or waiting-out the market.

### BRIEF SUMMARY

Embodiments of the present invention address these problems and/or other problems with an innovative housing purchase program. The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention provide apparatuses and methods that provide for an innovative housing purchase program in which a seller agrees to sell her home at a depressed price in return for the buyer agreeing to share with the seller some portion of any future appreciation in the home. For example, in some embodiments of the invention, the seller may desire, or even need, to sell a home at a first price but the potential buyer wants to purchase the home at a lower price. The seller may agree to sell the home at a price lower than that which the seller desires, but only if the buyer agrees to share some portion of the home's future appreciation in the event that the home appreciates during some defined time period.

In some embodiments, the housing purchase program further includes a mortgagee or other investor that, at least temporarily, pays off or forgives the seller's remaining mortgage principal that is above the sale price. In one such embodiment, the seller agrees to pay the mortgagee or other investor back with at least a portion any future appreciation in which the seller shares.

For example, in accordance with one embodiment of the invention, a seller may have a house that the seller desires to sell. The seller still owes $400,000 on the house and yet the seller cannot sell the house for $400,000 or more because of a slumping housing market. A potential buyer may be very interested in buying the seller's house, but only for up to $380,000. Because the seller still owes $400,000 on the house, the seller may not be willing to sell for anything significantly less than $400,000 because the seller may not have the money to pay off the seller's mortgagee at closing. The seller may also be hopeful that the housing market will rebound quickly and does not want to risk selling at what the seller may think is the market bottom. Traditionally, a seller in this situation will simply not sell and the buyer will miss out on the house that the buyer wants because the seller will not come down closer to current market value for the house. This situation results in properties sitting on the market for longer periods of time at prices that are above market price and delays the realization of a market bottom. Eventually, if the market does not turn around quick enough, the seller may choose to walk away from the house and let the bank foreclose. However, embodiments of the home purchase program described herein can solve this situation by allowing the seller, in this example, to sell below the seller's $400,000 mortgage balance. Specifically, embodiments of the home purchase program can permit the seller to sell the house to the buyer for $380,000. The seller's mortgagee then temporarily forgives the remaining $20,000 left on the mortgage. In return for the seller selling at this reduced price, the buyer agrees to share, for example, 25% of appreciation in the house after some defined time period. The seller then agrees to use the seller's share of this appreciation to pay the mortgagee back for temporarily forgiving the $20,000 of the seller's mortgage principal. In this way, the buyer gets the house that the buyer wants for the depressed price that the buyer desires, the seller avoids foreclosure and can sell the house without having to bring significant amounts of money to the closing, and the mortgagee avoids foreclosure and can be made whole if the home appreciates. If the housing market continues to decline during the time period defined by the home purchase program (i.e., if there is no appreciation), then the seller and mortgagee will not collect any money. However, had the seller not sold and the market declined further, the seller and mortgagee would have been in an even worse position. If, instead, the housing market rebounds during the time period defined by the home purchase program, then the seller and/or mortgagee will share in a portion of the appreciation. In sum, embodiments of the invention diversify the risk in the housing market and, thereby, can reduce the number of foreclosures and result in a quicker and more accurate determination of the market bottom and market rebound.

In this regard, embodiments of the invention provide, amongst other things, a method involving: (1) determining a desired sale price for property being sold by the seller, wherein the desired sale price comprises a price at which the seller would sell the property; (2) determining a modified sale price for the property, wherein the modified sale price is less than the desired sale price; and (3) storing in a tangible storage medium terms of an agreement between a buyer and the seller, wherein the terms comprise the seller selling the property to the buyer at the modified sale price at least partially in return for the buyer agreeing to provide the seller with a portion of the property's future appreciation in value. In some embodiments, the method further involves: receiving a subsequent sale price from a sale of the property by the buyer; calculating, using a processor, an amount of money to be paid to the seller based at least in part on the subsequent sale price; and storing the amount of money in a non-transitory computer readable storage medium.

In some embodiments of the invention, the method further includes: determining a benefit provided to the seller by an investor; and storing in a tangible storage medium terms of an agreement of an agreement between the seller and the investor, wherein the terms comprise the investor providing the benefit to the seller at least partially in return for the seller agreeing to provide the investor with at least a portion of the seller's portion of the property's future appreciation in value. In some such embodiments, the method may also involve: receiving a subsequent sale price from a sale of the property by the buyer; calculating using a processor a first amount of money to be paid to the seller based at least in part on the sale price; calculating using a processor a second amount of money to be paid to the investor from the first amount of money based at least partially on the benefit provided to the seller by the investor; and storing the first and second amounts of money in a non-transitory computer readable storage medium. In some such embodiments, the investor is a mortgagee for the seller's mortgage on the property, and the benefit provided to the seller by the investor comprises at least temporary payment or forgiveness of a portion of the seller's mortgage obligation.

Some embodiments of the method further involve: performing a valuation of the property at some predefined point in time after the selling of the property to the buyer; calculating using a processor an amount of money to be paid to the seller based at least in part on the valuation; and storing the amount of money in a non-transitory computer readable storage medium. In some embodiments, the property includes real estate. In some embodiments, the tangible storage medium is a non-transitory computer-readable medium. In some embodiments, the desired sale price is based at least in part on a balance of a loan obligation owed by the seller and for which the property is collateral.

Embodiments of the invention also provide an apparatus having a memory system. The memory includes terms stored therein of an agreement regarding real estate. The terms include a seller selling the real estate to a buyer at least partially in return for the buyer agreeing to provide the seller with a portion of the real estate's future appreciation in value. Some embodiments of the apparatus also include a communication device and a processor operatively coupled to the communication device and the memory system. The communication device is configured to receive a subsequent sale price from a sale of the real estate by the buyer to a subsequent buyer. The processor is configured to calculate an amount of money to be paid to the seller based at least in part on the subsequent sale price.

In some embodiments of the apparatus, the terms further include an investor providing a benefit to the seller at least partially in return for the seller agreeing to provide the investor with at least a portion of the seller's portion of the real estate's future appreciation in value. In some such embodiments, the apparatus includes a communication device configured to receive an indication of a subsequent sale price from a sale of the real estate by the buyer to a subsequent buyer; and a processor communicably coupled to the communication device and the memory system. The processor is configured to: calculate first amount of money to be paid to the seller based at least in part on the sale price; and calculate a second amount of money to be paid to the investor from the first amount of money based at least partially on the benefit provided to the seller by the investor. In some embodiments, the processor is also configured to: order a valuation of the property at some predefined point in time after the selling of the property to the buyer; and calculate an amount of money to be paid to the seller based at least in part on the valuation.

Embodiments of the invention also provide a computer program product comprising non-transitory computer readable medium, where the non-transitory computer readable medium comprises computer-executable program code stored therein. The computer-executable program code includes: (1) a first executable portion configured for determining a desired sale price for property being sold by the seller, wherein the desired sale price comprises a price at which the seller would sell the property; (2) a second executable portion configured for determining a modified sale price for the property, wherein the modified sale price is less than the desired sale price; and (3) a third executable portion configured for storing in a tangible storage medium terms of an agreement between a buyer and the seller, wherein the terms comprise the seller selling the property to the buyer at the modified sale price at least partially in return for the buyer agreeing to provide the seller with a portion of the property's future appreciation in value. In some embodiments, the computer program product further includes: a fourth executable code portion configured for determining a benefit provided to the seller by an investor; and a fifth executable code portion configured for storing in a tangible storage medium terms of an agreement of an agreement between the seller and the investor, wherein the terms comprise the investor providing the benefit to the seller at least partially in return for the seller agreeing to provide the investor with at least a portion of the seller's portion of the property's future appreciation in value.

Embodiments of the invention also provide a method involving: (1) determining a value of a residence; (2) determining a difference between the value of the residence and a price for which the current owner purchased the residence; (3) using a processor to calculate a pre-defined portion of the difference between the value of the residence and the price for which the current owner purchased the residence; and (4) determining that at least a portion of the pre-defined portion is to paid to a previous owner of the residence. In some embodiments, the method further involves determining that at least a portion of the pre-defined portion is to be paid to a mortgagee for a mortgage that was held by the previous owner of the residence.

Embodiments of the invention also provide an apparatus having a communication device for receiving a value of a residence. The apparatus also includes a processor operatively coupled to the communication device. The processor is configured to: (1) determine a difference between the value of the residence and a price for which the current owner purchased the residence; (2) calculate a pre-defined portion of the difference between the value of the residence and the price for which the current owner purchased the residence; and (3) determine that at least a portion of the pre-defined portion is to paid to a previous owner of the residence. In some embodiments of the apparatus, the processor is further configured to determine that at least a portion of the pre-defined portion is to be paid to a mortgagee for a mortgage that was held by the previous owner of the residence.

The features, functions, and advantages that have been discussed and other features, functions, and advantages may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a flow chart illustrating a home purchase program in accordance with an embodiment of the invention;

FIG. 2 provides a flow chart illustrating a home purchase program in accordance with another embodiment of the invention;

FIG. 3 provides a flow chart illustrating an example home purchase program in greater detail, in accordance with one exemplary embodiment of the invention;

FIG. 4 provides a flow chart illustrating an example of a sale of a home by the buyer to a subsequent buyer under one example embodiment of the home purchase program;

FIG. 5 provides a block diagram illustrating an embodiment of a tangible storage medium having the home purchase program terms stored therein in accordance with an exemplary embodiment of the invention;

FIG. 6A provides an illustration of an example of possible results of a home purchase program in accordance with an example embodiment of the invention;

FIG. 6B provides an illustration of another example of possible results of a home purchase program in accordance with an example embodiment of the invention;

FIG. 7A provides a table illustrating a sliding scale of the seller's share of appreciation based on the extent that the buyer's purchase price is below seller's mortgage obligation, in accordance with an embodiment of the invention;

FIG. 7B provides a table illustrating a sliding scale of the investor's share of appreciation based on the investor's investment relative to the buyer's purchase price, in accordance with an embodiment of the invention;

FIG. 8 provides a block diagram illustrating an example of a computer system for managing the home purchase program in accordance with an embodiment of the invention; and

FIG. 9 provides a flow diagram illustrating and example of a process performed by the computer system of FIG. 8, in accordance with an embodiment of the invention.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

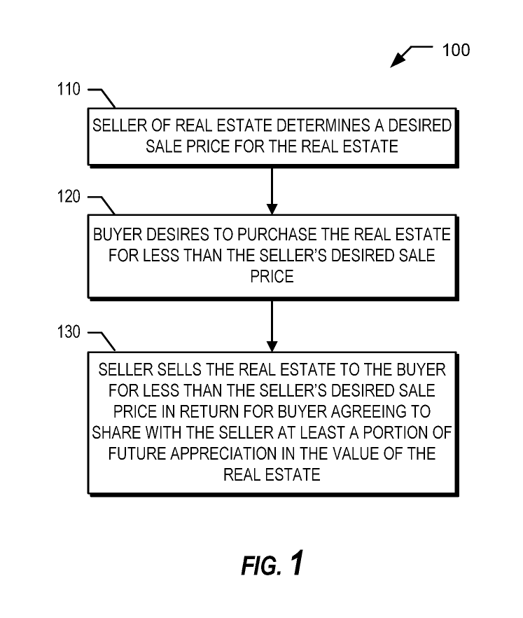

FIG. 1 provides a flow chart illustrating a process 100 for a home purchase program in accordance with an embodiment of the invention. As represented by block 110, the seller of real estate determines a desired sale price for the real estate. As represented by block 120, a buyer desires to purchase the real estate for less than the seller's desired sale price. As represented by block 130, the seller then agrees to sell the real estate to the buyer for less than the seller's desired sale price in return for the buyer agreeing to share with the seller at least a portion of future appreciation in the real estate.

For example, a seller may desire to sell a home for $300,000 but the only buyer currently interested in the seller's house may desire to purchase the property for only $260,000, which may be too low for the seller. In accordance with one embodiment of the invention illustrated in FIG. 1, the seller may agree to sell the house to the buyer for $260,000 in return for the buyer agreeing to give the seller fifty percent of any appreciation in the house when the current buyer later sells to a subsequent buyer. Supposing, for example, that the buyer sells the house three years later for $310,000 resulting in an appreciation of $50,000 relative to the buyer's purchase price. In one example embodiment of the home purchase program, the original seller (i.e., the seller that sold the house to the buyer under the home purchase program) and the original buyer (i.e., the buyer that purchased the house from the original seller under the home purchase program) would each then receive $25,000 of the realized appreciation from the original buyer's sale of the house to a subsequent buyer.

As described in greater detail below, future appreciation is determined according to agreed upon rules between the seller and the buyer. In one embodiment, the seller and buyer agree upon a time in the future at which appreciation will be determined. The time in the future could be defined by a particular date, date range, and/or event. Furthermore, appreciation may be determined based on the buyer's sale to a subsequent buyer or based on a valuation, such as an independent appraisal. For example, in one embodiment, the time of valuation is defined to be: (1) the date of buyer's good faith sale to a subsequent buyer if the sale falls within a predefined time period (e.g., between a minimum and maximum length of time after the current sale of the house from the seller to the buyer); or (2) the date of an appraisal at the end of the predefined time period if the buyer does not sell the home within the predefined time period. In some embodiments, the seller and buyer may agree that the buyer will pay the seller a lump sum or other penalty if the buyer sells the home prior to the start of the predefined time period.

In some embodiments of the invention, the seller's desired sale price is equal to the seller's remaining mortgage obligation (e.g., the seller's mortgage principal balance at the time of sale to the buyer). In another embodiment, the seller's desired sale price is some predefined percentage or amount above the seller's remaining mortgage obligation. In still other embodiments, the seller's desired sale price is the seller's remaining mortgage obligation plus some percentage of the cost or value of any improvements to the house made buy the seller since the seller purchased the property. In such embodiments where the seller's desired sale price is based at least in part on the seller's remaining mortgage obligation, the seller's remaining mortgage obligation may take into account the first mortgage only, the first mortgage and the second mortgage only, or any combination of the seller's mortgages and/or home equity lines of credit (HELOCs). In some embodiments, the seller's desired sale price is some percentage of the house's tax value, the house's appraised value, or the seller's purchase price for the house. In still other embodiments, the seller's desired sale price may be any price desired by the seller.

As used herein, the seller and the buyer may each be an individual, a company, or any other entity. The real estate may include land, one or more houses or other structures, and/or the like. However, it should be appreciated in view of this disclosure that embodiments of the present invention are not necessarily limited to real estate and may be used for the purchase of any other property where the property has a chance to appreciate in value.

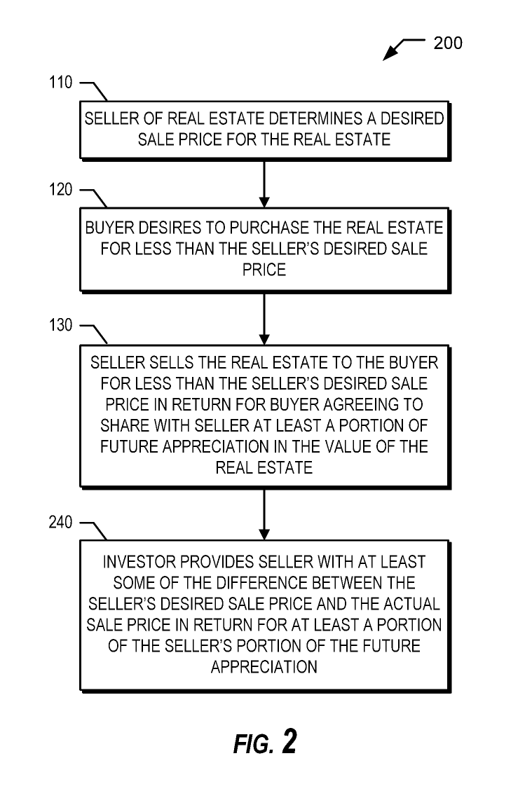

FIG. 1 illustrates a high-level illustration of an embodiment of the home purchase program. As described in greater detail below, some embodiments of the home purchase program include other features, terms, limitations, rules, boundaries, parties, considerations, and/or the like not shown in FIG. 1. For example, FIGS. 2 through 9 illustrate exemplary embodiments of the home purchase program of FIG. 1 where one or more of these other features, terms, limitations, rules, boundaries, parties, considerations, and/or the like exist. It will be appreciated that embodiments of the present invention are not limited to these other features, terms, limitations, rules, boundaries, parties, considerations, and/or the like unless expressly recited by the claims.

FIG. 2 provides a flow chart illustrating a process 200 of a home purchase program in accordance with another embodiment of the invention. As illustrated by blocks 110, 120, and 130, FIG. 2 involves the same process illustrated in FIG. 1 with the addition that an investor provides the seller with at least some of the difference between the seller's desired sale price and the actual sale price. In return, the seller agrees to pay the investor at least a portion of the seller's future share in the future appreciation of the property. This additional aspect of the process 200 is illustrated in FIG. 2 by block 240.

For example, in the example provided above where the seller desires to sell her home for $300,000 but instead decides to sell the home to a buyer for $260,000 in return for the buyer agreeing to provide the seller with fifty percent of the house's future appreciation, suppose that the seller did not wish to sell below $300,000 because the seller still owes $290,000 on the mortgage and recently invested $10,000 into hardwood floors for the home. In the embodiment of the invention illustrated in FIG. 2, an investor may agree to cover the $30,000 of the seller's mortgage that would otherwise remain after the sale to the buyer. In return, the seller may agree to pay the investor the first $30,000 of the seller's share of the future appreciation in the home plus interest.

In some embodiments of the process 200 the investor is paid a portion of the seller's share from the seller, while in other embodiments of the process 200 the investor takes a portion of the seller's share directly from some other party during the buyer's future sale of the property (e.g., from the subsequent buyer's mortgagee). In still other embodiments of the process 200, the investor is paid its portion of the seller's share from the buyer after the buyer sells the property. In some embodiments of the process 200, the investor receives a predefined percentage of the appreciation or of the seller's share in the appreciation. In other embodiments, the investor receives a lump sum (i.e., a pre-defined fixed monetary amount). In some embodiments of the process 200, the investor's portion of the seller's share of the appreciation is capped at the investor's investment (with or without interest) that was paid to the seller during the original sale of the property. In some embodiments, the investor takes her share of the seller's appreciation before the seller, while in other embodiments the investor and the seller each take a predetermined percentage of the appreciation.

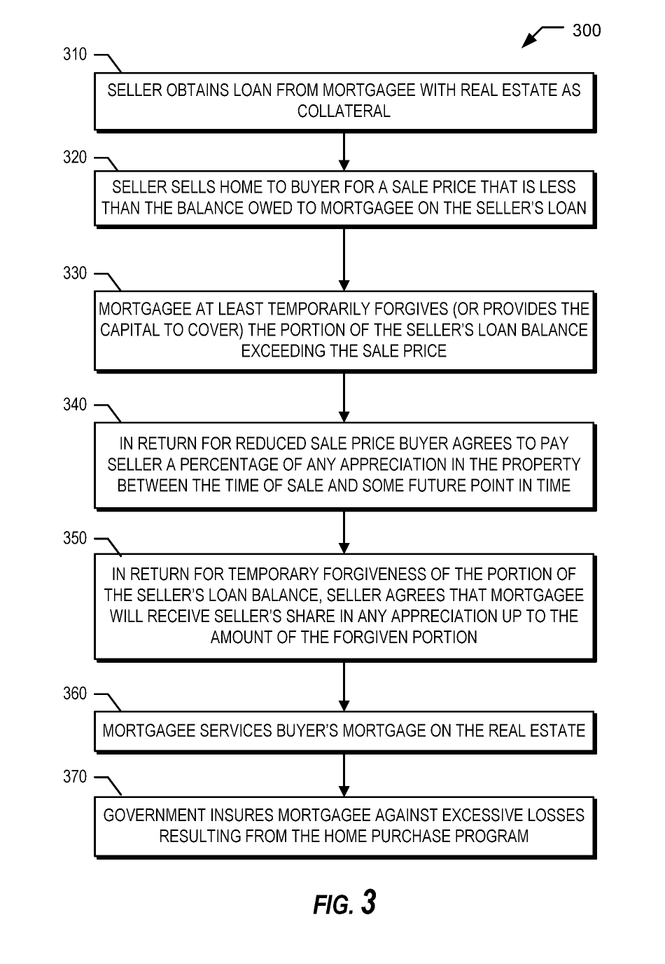

As used herein, an investor may be a bank or other financial institution. For example, in one embodiment described in greater detail below with respect to FIG. 3, the investor is the mortgagee for the seller's mortgage. In another embodiment, the investor is the mortgagee for the buyer's mortgage. In still other embodiments, the investor is a financial institution that is not otherwise involved with the buyer or seller. In still other embodiments of the home purchase program, the investor may be some other type of business or organization, an individual, or any other investor willing to provide the seller with money in return for at least a portion of the seller's share of appreciation when the buyer later sells the property. It should be understood that terms like “bank” and “financial institution” are used herein in their broadest sense. Institutions, organizations, or even individuals that process financial transactions are widely varied in their organization and structure. Terms like financial institution are intended to encompass all such possibilities, including but not limited to banks, finance companies, stock brokerages, credit unions, savings and loans, mortgage companies, insurance companies, credit card companies, payment network companies (e.g., Visa®, MasterCard®, American Express®, etc.), and/or the like.

FIG. 3 provides a flow chart illustrating a process 300 for an example home purchase program where the property involved is real estate and the investor is the seller's mortgagee, in accordance with one exemplary embodiment of the invention. As represented by block 310, the seller obtains a loan from a mortgagee and uses real estate as collateral for the loan. The loan may be, for example, a first mortgage, a second mortgage, a HELOC, and/or any other type of loan or combination of loans where real estate is the collateral for the loan. The mortgagee may be, for example, a bank or other financial institution. The mortgagee may be a mortgage originator, servicer, investor, or any other financial institution involved in providing a loan to the seller.

As represented by block 320, at some point the seller sells the home to a buyer for a sale price that is less than the balance owed on the seller's loan. For example, the real estate market could have trended downward in the seller's region since the seller's purchase or refinance causing the apparent value of the real estate to drop below the seller's loan balance. This may be especially likely where the seller's loan had a high loan-to-value (LTV) ratio at the outset.

As represented by block 330, the mortgagee then “covers” (i.e., at least temporarily pays or forgives) the portion of the seller's loan balance that exceeds the sale price. In some embodiments, the mortgagee also covers some additional expenses associated with the sale, such as certain realtor fees or other closing costs. Where, in this example, the mortgagee owns or services the seller's loan, the mortgagee may simply forgive a portion of the seller's loan balance. In other examples, however, the mortgagee may pay off a portion of the seller's loan balance and/or provide a new loan to the seller in the amount of a portion of the seller's loan balance so that the seller can pay off the remaining loan balance. As described in greater detail below, this forgiving or paying of a portion of the seller's loan balance may be considered to be only temporary because, if the house appreciates, then the seller pays some or all of this money back to the mortgagee, in accordance with the illustrated embodiment of the home purchase program.

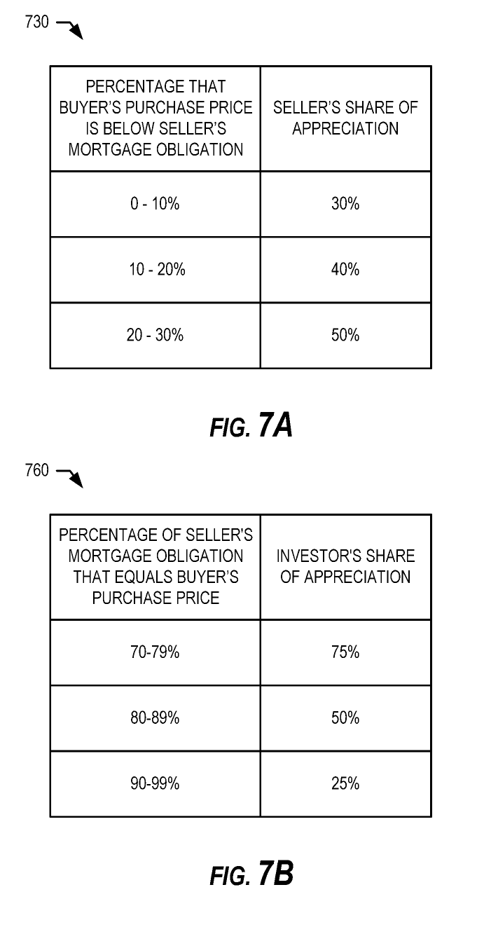

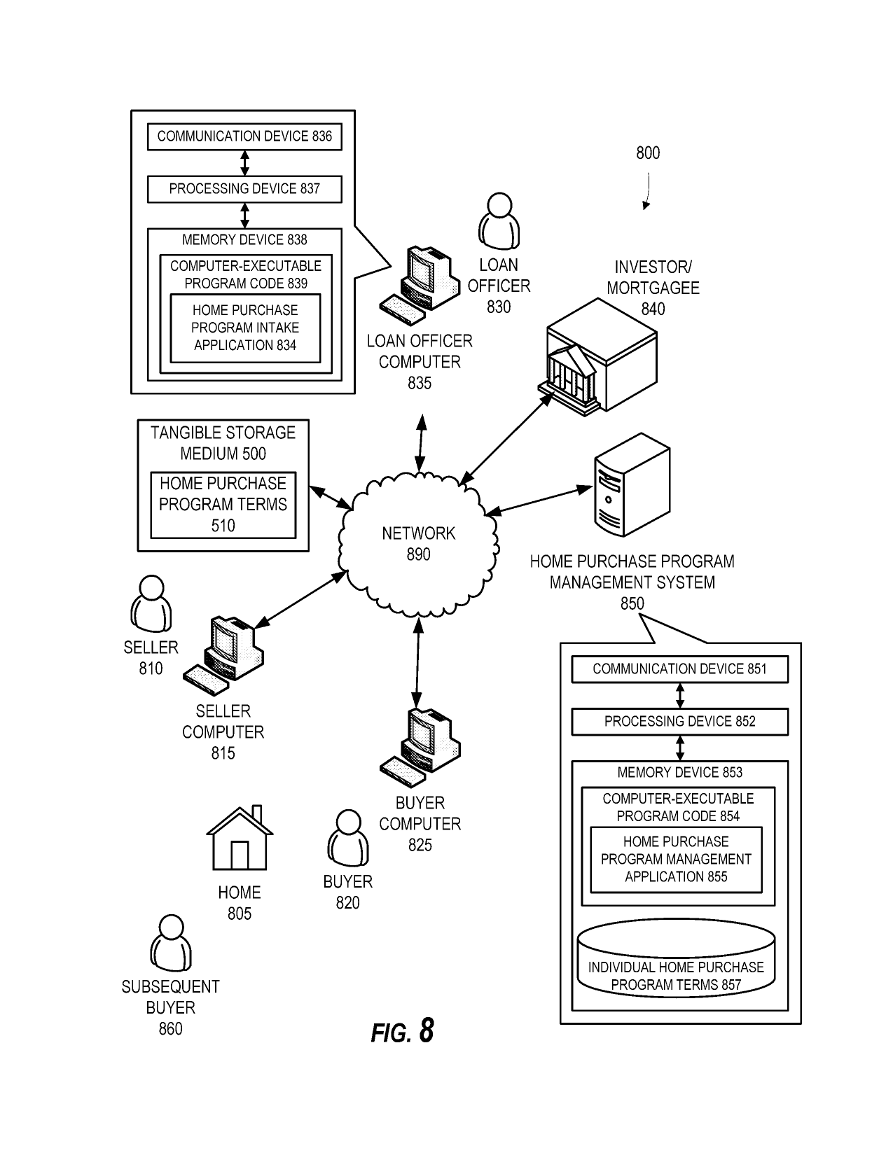

As represented by block 340, in return for the reduced sale price, the buyer agrees to pay the seller some predefined portion of any appreciation in the property between the time of the sale and some future point in time. In some embodiments of the home purchase program, the predefined portion of the appreciation is a predefined percentage of the appreciation. For example, the percentage may be 10%, 25%, 30%, 50%, 60% or any other percentage. In one embodiment of the invention, the percentage is based on the difference between the sale price and some other price or valuation for the property, such as the seller's desired sale price, an appraisal, the seller's remaining mortgage obligation, the seller's original purchase price, and/or the like. In this regard, FIG. 7A provides a table 730 illustrating an embodiment of the invention where the seller's percentage share in the future appreciation is based at least in part on the sale price. Specifically, in this example, the lower the sale price the greater the seller's share of the appreciation. For example, in the illustrated embodiment of FIG. 7A, when the buyer's purchase price is between zero and ten percent below the seller's mortgage obligation, the seller will get thirty percent of the future appreciation. When the buyer's purchase price is between ten and twenty percent below the seller's mortgage obligation, the seller will get forty percent of the future appreciation. When the buyer's purchase price is between twenty and thirty percent below the seller's mortgage obligation, the seller will get fifty percent of the future appreciation. Embodiments such as these, where the seller's share of the appreciation increases as the buyer's purchase price decreases, may be beneficial by providing a disincentive for the buyer to under-bid too aggressively in a poor housing market. This may prevent prices in the housing market from dropping lower than where they should be simply because of temporary misperceptions and overreactions.

Although some embodiments of the invention may apportion some of the future appreciation to the seller based on a predefined percentage, other embodiments of the invention may define a lump sum (i.e., a fixed monetary amount) that is to be paid to the seller based on the appreciation. The lump sum may be a predefined amount or based on predefined rules. For example, in one embodiment of the home purchase program, the buyer agrees to pay the seller a particular amount of money if an appraisal taken two years after the sale indicates that the home has appreciated to some predefined level. In some embodiments, the lump sum is based on the buyer's purchase price (similar to the embodiment described in FIG. 7A).

In some embodiments of the invention, the seller's share of the appreciation is defined by both percentages and predefined lump sums. For example, the seller's share of the appreciation may be based on some predefined percentage unless the buyer sells the home before some predefined minimum length of time after the buyer's purchase of the home, in which case the buyer would pay the seller the greater of the predefined percentage or a predefined lump sum. For example, the home purchase program may provide that the seller gets 25% of the home's appreciation provided that the buyer sells the home after two years. The home purchase program may further provide that, if the buyer sells the home before two years, the buyer pays the seller a $10,000 penalty in lieu of the appreciation if 25% of the appreciation at the time of the buyer's sale is less than $10,000.

In some embodiments, the home purchase program includes minimum and/or maximums for the seller's share of the buyer's future appreciation. For example, the seller's share may be based on a predefined percentage of the buyer's future appreciation in the home, but may be capped at a predefined lump sum and/or the seller may be guaranteed a minimum lump sum. In one embodiment of the home purchase program, the seller's share is capped at the difference between the seller's desired price and the seller's sale price.

As described above, the future point in time may be a specific predefined date, some predefined length of time from the buyer's purchase of the home, the date of an event such as the buyer's sale of the home or an appraisal. In some embodiments, the future point of time is defined by the date of a future event, such as a sale, but only if the event occurs within a predefined time range. In such embodiments, the future point in time may be a particular predefined date if the event does not occur within the predefined time range.

As represented by block 350, in return for the mortgagee temporarily covering (i.e., forgiving or paying) the portion of the seller's loan balance, the seller agrees that the mortgagee will receive at least a portion of seller's share in the appreciation. In one embodiment of the home purchase program, the mortgagee's portion of the appreciation is limited to the amount of the seller's mortgage obligation that was covered by the mortgagee. In other embodiments, the mortgagee's portion of the appreciation is limited to the amount of the seller's mortgage obligation that was covered by the mortgagee plus some predefined interest on this amount. In still other embodiments, the mortgagee's share is a predefined lump sum or percentage of the appreciation. In some embodiments, the mortgagee has priority over the seller and the mortgagee takes its portion of the appreciation before the seller receives any portion of the appreciation. The mortgagee may receive its portion of the seller's share in the appreciation from the seller, buyer, a subsequent buyer, a trustee, or a third party financial institution such as, for example, a subsequent buyer's mortgagee. In some embodiments, the investor's share of the appreciation is based on the investor's investment, or in the case of a mortgagee on the mortgage obligation, relative to the seller's original purchase price for the home or the buyer's purchase price for the home. For example, FIG. 7B provides a table 760 illustrating a sliding scale of the investor's share of appreciation based on the investor's investment relative to the buyer's purchase price, in accordance with an embodiment of the invention. Specifically, in this example, the lower the buyer's purchase price is relative to the seller's mortgage obligation the greater the investor's share of the appreciation (i.e., the greater the investor's investment, the greater the investor's percentage share in the appreciation). For example, in the illustrated embodiment of FIG. 7B: when the buyer's purchase price is between seventy and seventy-nine percent of the seller's mortgage obligation, the seller will get seventy-five percent of the future appreciation (in some instances up to a maximum amount); when the buyer's purchase price is between eighty and eighty-nine percent of the seller's mortgage obligation, the seller will get fifty percent of the future appreciation (in some instances up to a maximum amount); and when the buyer's purchase price is between ninety and ninety-nine percent of the seller's mortgage obligation, the seller will get twenty-five percent of the future appreciation (in some instances up to a maximum amount).

As represented by block 360, in some embodiments of the invention the mortgagee services, owns, or is otherwise involved with the buyer's mortgage on the real estate after the sale to of the real estate to the buyer. For example, in one embodiment of the home purchase program, as a condition for the home purchase program the mortgagee has the right to service or own the buyer's mortgage. In other embodiments, however, the mortgagee is not involved with the buyer's mortgage, which may be owned or serviced by another financial institution.

As represented by block 370, in some embodiments of the invention, the government, such as a federal government of the country in which the real estate exists, or some other organization or entity, such as an insurance company, insures the mortgagee against excessive losses resulting from the home purchase program in the event that, for example, a large percentage of the homes involved with the home purchase program experience significant declines in value and/or fail to significantly appreciate after a long period of time. Such a system may be beneficial to provide greater incentives for financial institutions to offer or otherwise engage in the home purchase program, which could be a good thing for the country or other community if the program helps to stop or slow the downward spiral of a housing market and helps the market to rebound more quickly.

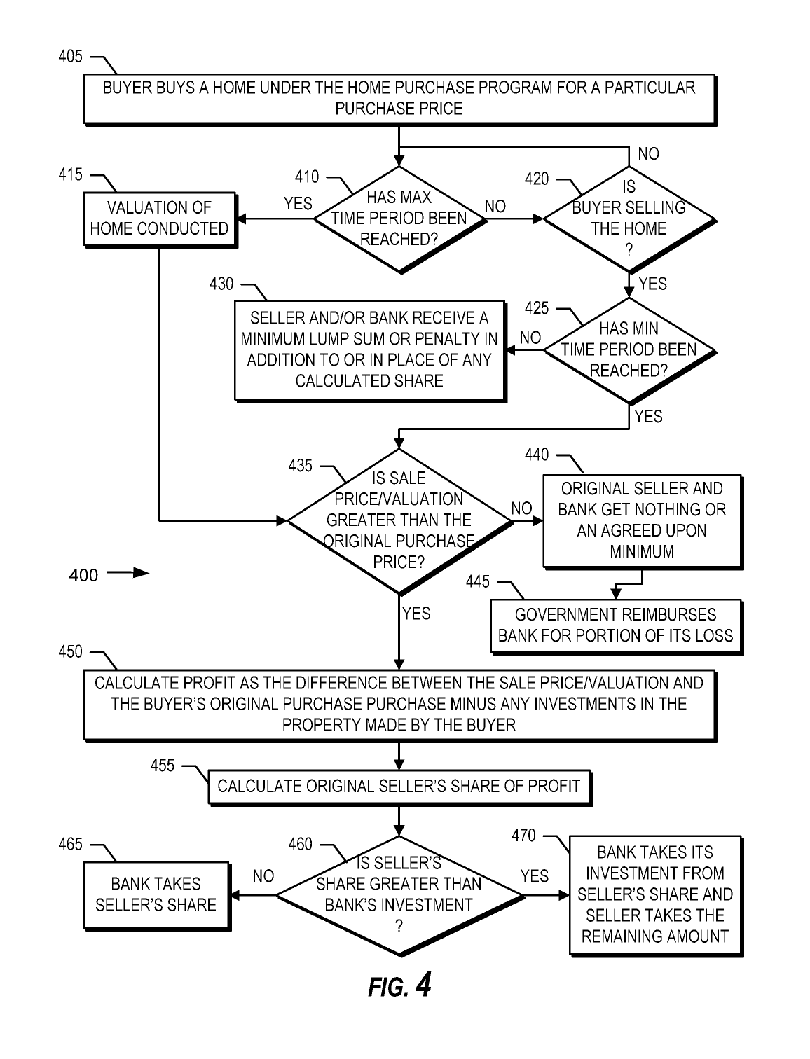

FIG. 4 provides a flow chart illustrating an example process 400 of a sale of a home by the buyer to a subsequent buyer under one example embodiment of the home purchase program. The process 400 illustrates just one example of a home purchase program where the buyer agrees to pay the seller or an investor bank some percentage of the home's appreciation upon a subsequent sale if the sale occurs within a predefined period of time. It will be appreciated in view of this disclosure that the sale process 400 is just one example and other embodiments of the sale process 400 may have fewer, more, or different steps based on the terms of the particular home purchase program.

As represented by block 405 and as described above, the buyer buys a home under the home purchase program for a particular purchase price and with particular predefined terms. In the illustrated embodiment of the home purchase program, the terms include a maximum time period before which buyer must sell for the appreciation to be based on an actual sale of the home. The illustrated embodiment also includes a minimum time period that the buyer must wait before selling the home in order to ensure that the appreciation will be calculated based on an actual sale of the home. In this regard, as represented by block 410, a determination is made about whether the maximum time period has been reached. If the maximum time period has been reached and there has been no sale of the home by the buyer, then a valuation of the home is conducted, as represented by block 415. The valuation may be determined by, for example, an independent appraisal or an automated valuation estimator. However, if the maximum time period has not been reached, then the process 400 proceeds to the step represented by block 420 where a determination is made as to whether the buyer is selling the home.

As illustrated in FIG. 4, if the buyer is not selling the home, then the process 400 loops back through decision blocks 410 and 420 until either the maximum time period is reached or the buyer sells the home. When it is determined that the buyer is selling the home, the process 400 then involves determining whether a minimum time period has been reached, as represented by block 425. If the minimum time period has not been reached, then, in one embodiment of the home purchase program, the seller and/or the bank receive a minimum lump sum or other penalty in addition to or in place of a predefined share in the appreciation in the home, as represented by block 430. For example, the home purchase program may have a minimum time period of two years and, if the buyer sells the home before two years pass between the buyer's purchase of the home and the buyer's sale of the home, then the buyer may be obligated to pay $10,000 on top of the seller's share in any appreciation determined from the sale price. Some embodiments of the home purchase program may have minimum time period terms such as this so that the home has a reasonable chance to appreciate before the seller's share in the appreciation is calculated. It will be appreciated that, although embodiments of the invention are sometimes described herein as involving a bank as the investor, other embodiments may involve other investors that are not banks.

As represented by decision block 435, if the minimum time period has been reached before the buyer sells the home, in accordance with decision block 425, or if a valuation is conducted in accordance with block 415, then a determination is made as to whether the buyer's sale price/valuation is greater than the buyer's original purchase price. As represented by block 440, if the buyer's sale price/valuation is not greater than the buyer's purchase price, then there is no appreciation and the original seller and the investor bank both get nothing or, if there is an agreed-upon minimum lump sum, the agreed-upon minimum lump sum. In some such embodiments, the government or some other entity reimburses the bank for some or all of its losses resulting from the home purchase program, as represented by block 445. In other embodiments, the bank fully absorbs any losses itself. It will be appreciated that, in some embodiments of the invention, determining whether there has been any appreciation may involve more than just comparing the buyer's sale price/valuation to the buyer's purchase price since the buyer may have made some improvements to the home between when the buyer purchased the home from the seller and when the buyer sold the home to a subsequent buyer. In some such embodiments, the buyer's improvements are valued and then added to the buyer's original purchase price before comparing the purchase price to the buyer's sale price/valuation. The value of any improvements may be determined based at least in part on an independent appraisal and/or on the cost of the improvements themselves.

As represented by block 450, if it is determined in decision block 435 that there has been appreciation in the home, then the process 400 involves calculating the buyer's “profit” as the difference between the buyer's sale price/valuation and the buyer's original purchase price, and then subtracting from this difference the value of any investments in the property made by the buyer. As represented by block 455, the original seller's share of the appreciation is then calculated by, for example, taking the pre-defined percentage of the buyer's profit calculated in step 450.

As represented by block 460, a determination is then made as to whether the seller's share in the appreciation is greater than the bank's investment (or other predefined bank share). As represented by block 465, if the seller's share is not greater than the bank's investment, then the bank takes all of what would be the seller's share. As represented by block 470, if the seller's share is greater than the bank's investment, then the bank takes its investment from the seller's share and then the seller takes any remaining amount of the seller's share. The bank may take its share from the seller or before the seller receives the seller's share.

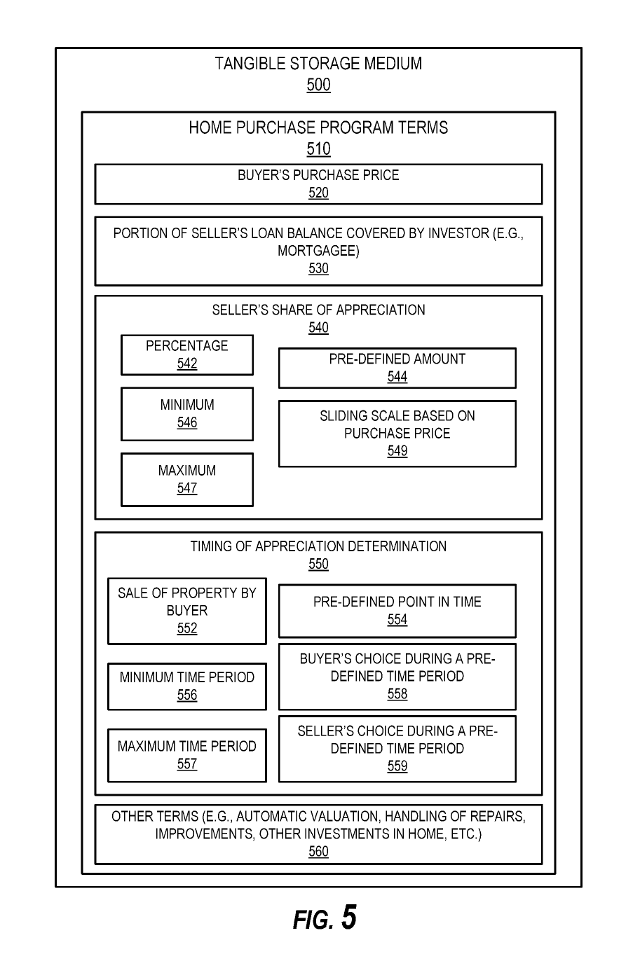

FIG. 5 provides a block diagram illustrating an embodiment of a tangible storage medium 500 having the home purchase program terms 510 stored therein in accordance with an exemplary embodiment of the invention. In this way, the terms are recorded as evidence of the agreement between the parties and can be used by the parties and/or home purchase program management systems to manage each home purchase program over time. As used herein, a tangible storage medium may be any tangible medium capable of storing the terms of the home purchase program. For example, the tangible storage medium may be a non-transitory computer-readable medium or even paper.

As illustrated in FIG. 5, the home purchase program terms 510 stored in the tangible storage medium 500 generally includes the buyer's purchase price 520, the portion of the seller's loan balance covered by the bank or other investor 530, a definition of the seller's share of the future appreciation 540, a definition of the timing of the appreciation determination 550, and/or other miscellaneous terms 560. The buyer's purchase price is the price at which the original buyer purchases the home from the original seller. The price may or may not include closing costs and/or other buyer expenses such as amounts paid from the seller to the buyer at closing to make particular repairs to the home.

In embodiments of the home purchase program where there is an investor, such as a bank, that covers a portion of the seller's loan balance so that the seller can sell the home to the buyer, this amount is stored in the tangible storage medium 500. In some embodiments where the investor is entitled to take a portion of the appreciation to cover interest on the investor's investment, an interest rate or rule for determining an interest rate is stored in the tangible storage medium 500.

As illustrated in FIG. 5, the seller's share of the appreciation 540 may be, for example, defined at least in part by a predefined percentage 542 of the appreciation, a pre-defined amount of money 544, a minimum lump sum 546, and/or a maximum lump sum 547. In some embodiments of the invention, the percentages and/or lump sums are determined by a sliding scale based on purchase price 549, which may also be stored in the tangible storage medium. For example, FIG. 7A illustrates an example of such a sliding scale 730 in accordance with an embodiment of the invention.

As illustrated in FIG. 5, the timing of the appreciation determination 550 may be, for example, defined by the timing of a good faith sale of the property by the buyer to a subsequent buyer 552, a predefined point or range in time 554, a minimum point in time 556, and/or a maximum point in time 557. For example, in one embodiment of the invention represented by term 558, a time range is defined during which the buyer can choose when to conduct a valuation of the property for purposes of determining the appreciation. For example, the time period may be between three and four years after the buyer's purchase of the property and the terms may allow the buyer to select any point of time during that time period to order an appraisal to use when calculating the appreciation from which the seller's share will be determined. In another embodiment of the invention represented by block 559, a time range is defined during which the seller can choose when to conduct a valuation of the property for purposes of determining the appreciation.

Other terms 560 may also be stored in the tangible storage medium 500, such as for example, terms defining how the property's value will be determined (e.g., by automatic valuation using a computer program or online value estimator, manually by a certified appraiser, with certain specific appraisal rules, by actual sale only, etc.), how repairs, improvements, and/or other investments in the property made by the buyer are handled in the appreciation calculation, and/or the like.

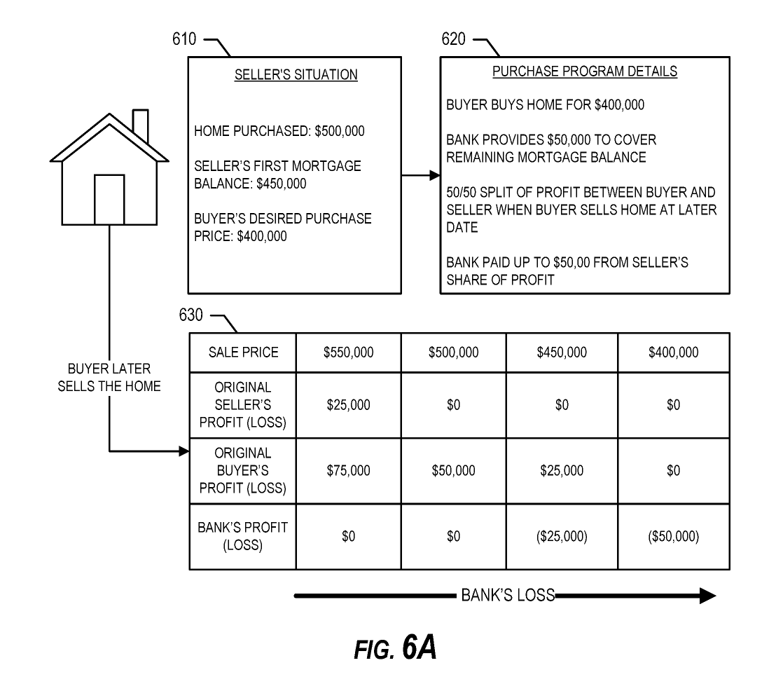

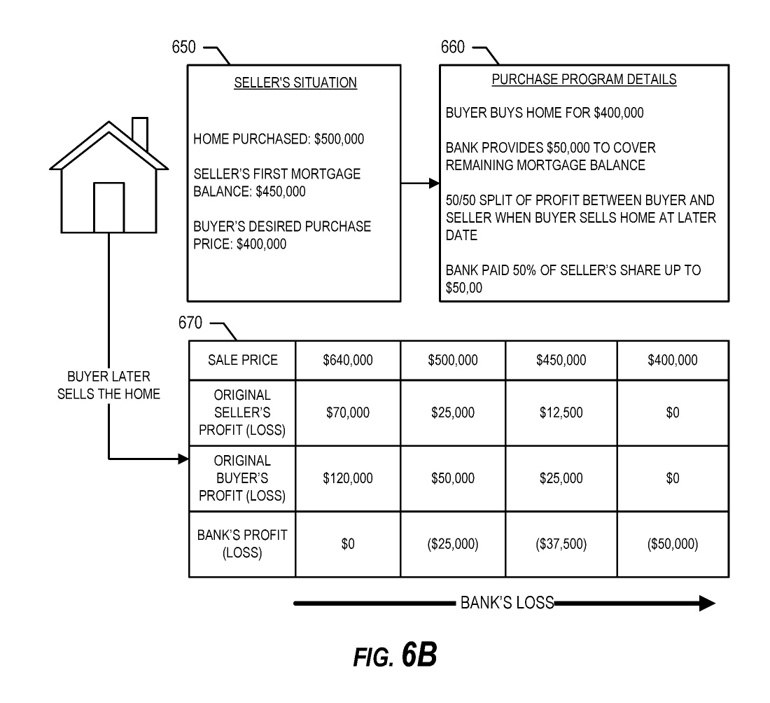

FIG. 6A provides an illustration of an example of possible results of a home purchase program in accordance with an example embodiment of the invention. In the illustrated example, the seller's situation 610 shows that the seller purchased the home for $500,000 and that the balance of the seller's first mortgage is currently $450,000. A potential buyer is very interested in purchasing seller's home, but the buyer will only pay $400,000 for the home. The seller, who may need to sell the home as soon as possible and who may not have any other potential buyers, must either sell the home or walk away and let the bank foreclose on the house. Under the example home purchase program 620, the seller does not walk away from the home and, instead, sells the home to the buyer for the bargain price of $400,000. The bank or other investor, which may be the seller's mortgagee, invests $50,000 to cover the seller's remaining mortgage obligation ($50,000 covered by bank+$400,000 paid by buyer=$450,000 still owed by seller on the mortgage). In return for the seller selling to buyer at such a low price, the buyer agrees to split 50/50 the buyer's profit when the buyer later sells the home. The seller agrees that, in return for the bank covering the remaining mortgage obligation, the bank can take the first $50,000 of the seller's share in the buyer's profit from a future sale.

Table 630 illustrates examples of several possible outcomes of this embodiment of the home purchase program when the buyer later sells the home. For example, several years after the buyer's purchase from the seller, the buyer could sell the home to a subsequent buyer for $550,000. In such an example, assuming that the buyer did not make improvements to the home, the profit from the sale of the home would be $150,000 ($550,000 sale price—$400,000 purchase price). The buyer would keep half of this, in other words $75,000. The bank would take the first $50,000 of the seller's $75,000 share to cover the bank's earlier payment of the seller's mortgage obligation.

The seller, therefore, would receive $25,000 from the buyer's subsequent sale of the home. In other words, the bank does not lose anything significant and avoids what might have otherwise been a foreclosure by the original seller. The buyer buys a property for which the buyer had a particular desire but that might normally be unaffordable for the buyer. The buyer also collects half of the property's future appreciation. The seller sells the home and avoids foreclosure and its negative effects on the seller's credit rating. The seller also does not have to pay the seller's remaining mortgage obligation when the seller originally sells the property to the buyer. The seller also makes $25,000 from the buyer's sale to a subsequent buyer, which somewhat compensates the seller for selling at a price that may in hindsight have been way too low considering that housing values quickly recovered and appreciated such a large amount.

In another example, the buyer sells the home for $500,000. In this example, the seller does not make any profit from the buyer's sale, the bank takes $50,000 from the sale to cover the original seller's mortgage obligation and therefore makes no profit, and the buyer makes $50,000 profit from the sale.

In another example, the buyer sells the home for $450,000. In this example, the seller does not make any profit from the buyer's sale, the bank takes only $25,000 from the sale to cover the original seller's mortgage obligation and therefore loses $25,000, and the buyer makes $25,000 profit from the sale.

In another example, the buyer sells the home for $400,000. In other words, the house does not appreciate at all. In this example, the seller does not make any profit from the buyer's sale, the bank takes no money from the sale and therefore loses $50,000 for covering the original seller's mortgage, and the buyer makes no profit from the sale.

Although not shown, in examples where the housing market further declines and the home actually depreciates in value, the seller does not make any profit and is in a better position having sold the property when the seller did compared if the seller had held onto the property longer. The bank losses the $50,000 that it invested by covering the original seller's mortgage, but the bank's losses are capped at this amount. The buyer loses money due to the home's declining value, but loses less than if the buyer had not received a bargain price from the seller to begin with and had instead purchased the home for, for example, the seller's remaining mortgage obligation or other desired sale price.

FIG. 6B provides an illustration of another example of possible results of a home purchase program in accordance with an example embodiment of the invention where the investor takes a predefined percentage of the seller's share. In the illustrated example, the seller's situation 650 shows that the seller purchased the home for $500,000 and that the balance of the seller's first mortgage is currently $450,000. A potential buyer is interested in purchasing seller's home, but the buyer will only pay $400,000 for the home. Under the example home purchase program 660, the sells the home to the buyer for the price of $400,000. The bank or other investor, which may be the seller's mortgagee, invests $50,000 to cover the seller's remaining mortgage obligation. In return for the seller selling to the buyer at such a low price, the buyer agrees to split 50/50 the buyer's profit when the buyer later sells the home. The seller agrees that, in return for the bank covering the remaining mortgage obligation, the bank can take 50% of the seller's share in the appreciation (i.e., 25% of the total appreciation) up until the bank receives its $50,000 investment back.

Table 670 illustrates examples of several possible outcomes of this embodiment of the home purchase program when the buyer later sells the home. For example, several years after the buyer's purchase from the seller, the buyer could sell the home to a subsequent buyer for $640,000. In such an example, assuming that the buyer did not make improvements to the home, the profit from the sale of the home would be $240,000. The buyer would keep half of this, in other words $120,000. The bank would take the fifty percent of the seller's $120,000 share up to $50,000 to cover the bank's earlier payment of the seller's mortgage obligation. In another example, the buyer sells the home for $500,000. In this example, the seller makes a $25,000 profit from the buyer's sale, the bank takes $25,000 from the sale resulting in a $25,000 loss, and the buyer makes $50,000 profit from the sale. In yet another example, the buyer sells the home for $450,000. In this example, the seller makes a $12,500 profit from the buyer's sale, the bank takes $12,500 from the sale resulting in a $37,500 loss, and the buyer makes $25,000 profit from the sale. In yet another example, the buyer sells the home for $400,000. In other words, the house does not appreciate at all. In this example, the seller does not make any profit from the buyer's sale, the bank takes no money from the sale and therefore loses $50,000 for covering the original seller's mortgage, and the buyer makes no profit from the sale.

FIG. 8 provides a block diagram illustrating an example home purchase program environment 800 and an example of a computer system 850 for managing the home purchase program in accordance with an embodiment of the invention. As illustrated in FIG. 8 and as described above, embodiments of the present invention may involve a seller 810, a buyer 820, a subsequent buyer 860, a home 805 or other real estate or property, an investor 840 that may or may not be the seller's mortgagee, and a loan officer 830. As described above, the seller 815 sells the home 805 to the buyer 820 with certain home purchase program terms described above, such as home purchase program terms 510. The home purchase program terms 510 may involve the seller and the buyer, or the seller, buyer, and investor. These terms 510 are then stored in a tangible storage medium 500 which can be used as evidence of the agreement between the parties and can be used to determine and calculate the rights and obligations of each party.

In some embodiments of the invention, the loan officer 830 uses a computer 835 to communicate with the seller 815, buyer 820, and/or investor 840 via, for example, a network 890 and a seller computer 815, buyer computer 825, and investor computer (not shown). In such an embodiment, the terms may be offered, discussed, and/or accepted using the computers and then stored in the memories of one or more of these computers or in other computer readable media. The network 890 may be any system for communicating information from one party to another and may include, for example, a global area network, wide area network, local area network, wireless network, wire-line network, secure encrypted network, virtual private network, one or more direct electrical connections, and/or the like.

In one embodiment of the invention, the environment 800 includes a home purchase program management system 850 for managing one or more buyer/seller/investor relationships participating in the home purchase program. In some embodiments, the home purchase program management system 850 is owned by, maintained by, or otherwise associated with the mortgagee 840 or other bank. In the illustrated embodiment, the home purchase program management system 850 includes a communication device 851 configured to communicate with one or more other devices on the network 890. As used herein, a “communication device” generally includes a modem, server, transceiver, and/or other device for communicating with other devices directly or via a network, and/or a user interface for communicating with one or more users. As used herein, a “user interface” generally includes a display, mouse, keyboard, button, touchpad, touch screen, microphone, speaker, LED, light, joystick, switch, buzzer, bell, and/or other user input/output device for communicating with one or more users.

The home purchase program management system 850 also includes a memory device 853. As used herein, a “memory device” generally refers to a device or combination of devices including one or more forms of computer-readable media for storing instructions, computer-executable code, and/or data thereon. Computer-readable media is defined in greater detail herein below. The memory device 853 includes computer executable program code 854 such as a home purchase program management application 855. The memory device 853 also includes stored therein the home purchase program terms 857 of each individual home purchase program participant.

The home purchase program management system 850 also includes a processing device 852 operatively coupled to the communication device 851 and the memory device 853. As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. It will be appreciated that the processing device, communication device, and memory device may each be made up of a single device or many separate devices that conceptually may be thought of as a single device.

The processing device 852 is configured to perform one or more of the steps of the flow charts described herein by, for example, executing computer executable program code of the home purchase program management application 855. For example, the home purchase program management system 850 may be configured to receive and approve applications for the home purchase program, store terms of individual program participants, calculate rights and obligations for the different participants, monitor time periods, notify appropriate persons when certain conditions are satisfied, automatically order valuations at appropriate times, track whether rights received and obligations are paid, monitor gains and losses, apply for reimbursement by the government or insurance entity, and/or the like. In some embodiments of the invention, the home purchase program management system 850 is configured to interact with a loan officer's computer to receive information about potential participants, provide possible terms for those participants, receive program applications, and provide program approval. In this regard, the loan office computer may include in its memory device 838 a home purchase program intake application 834 that assists the loan officer 830 when the loan officer is working out the details of a home purchase program with a seller 810 and a buyer 820.

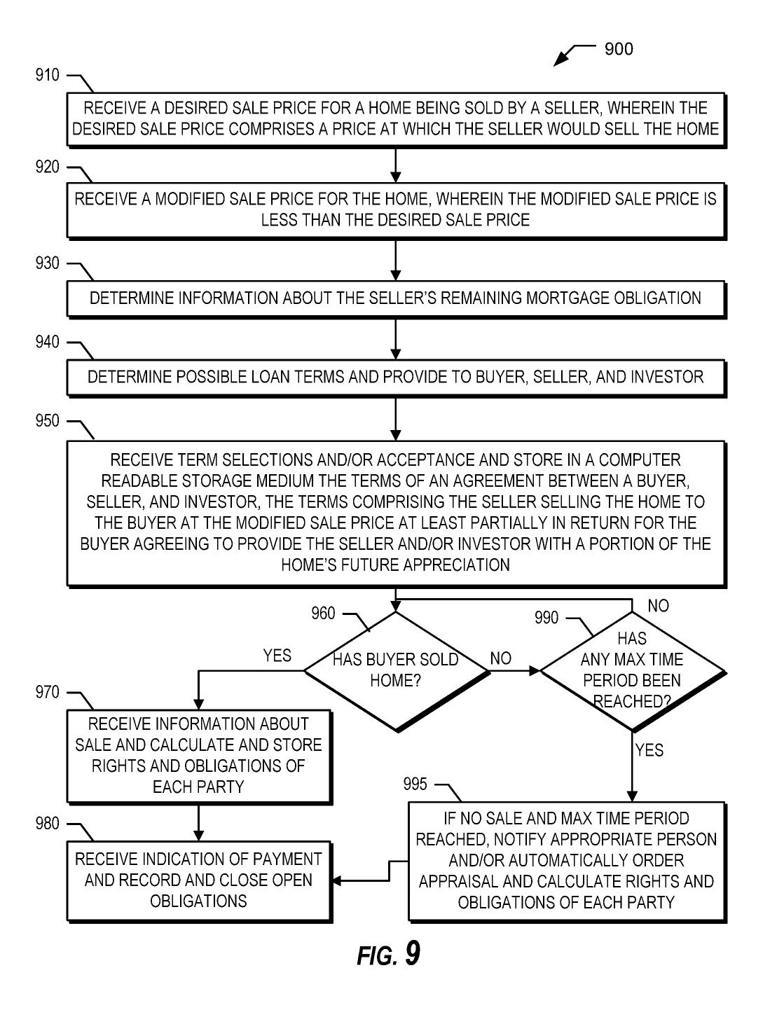

FIG. 9 provides a flow diagram illustrating an example of a process 900 that may be performed by the home purchase program management system 850 of FIG. 8, in accordance with an embodiment of the invention. As represented by block 910, the system 850 receives a desired sale price for a home 805 being sold by a seller 810, wherein the desired sale price is a price at which the seller would sell the home. For example, the seller may desire to sell the home for nothing less than the seller's current mortgage obligation, the seller's original purchase price, the seller's current mortgage obligation plus the value of the seller's recent improvements, the home's appraised value, and/or the like. In some embodiments, the seller 810 goes to a loan officer 830 and the loan officer 830 enters the seller's desired sale price into a computer 835 which then communicates the seller's desired sale price to the home purchase mortgage system 850.

As represented by block 920, the system 850 then receives a modified sale price for the home 805, wherein the modified sale price is less than the desired sale price. For example, the modified sale price may be the price for which the buyer 820 would like to by the home 805. This may also be received through, for example, the loan officer's computer 835.

As represented by block 930, the system 850 may also be configured to determine information about the seller's remaining mortgage obligation on the home 805. For example, this information may also be received from the loan officer's computer 835 or it may be received directly from the mortgagee's computer system 840. In some embodiments where the system 850 is owned or maintained by the mortgagee 840, this information may be already stored in the system's memory device 853.

As represented by block 940, the system 850 may then use these inputs to determine and rules and business parameters stored in the home purchase program management application 855 to determine possible loan terms for these potential participants. The system 850 then provides these terms to the buyer 820, seller 810, and/or investor/mortgagee 840 via the loan officer 830 or one or more of their respective computers.

As represented by block 950, the system 850 then receives from one or more of the computers term selections and/or acceptances and stores them in its memory device 853. The terms are of an agreement between the buyer 820, seller 810, and investor 840, and the terms comprise the seller 810 selling the home 805 to the buyer 820 at the modified sale price at least partially in return for the buyer 820 agreeing to provide the seller 810 and/or investor 840 with a portion of the home's future appreciation.

As represented by decision block 960, after the agreement is entered into, the system 850 determines whether the buyer 820 has sold the home 805 to a subsequent buyer 860. As represented by block 970, when it is determined that the buyer has sold the home, then the system 850 receives information about the sale and calculates the rights and obligations of each party to the agreement and stores these rights and obligations in the memory device 853 and/or takes other action based on these rights and/or obligations. As represented by block 980, the system 850 then receives indications of payments from one party to another based on the agreement and records these payments and closes open obligations as appropriate.

However, if the buyer 820 has not sold the home 805, then, as represented by decision block 990, the system 850 determines whether any max time period has been reached for the agreement. If a max time period has not been reached, the system loops through the decision blocks 960 and 990 until either the buyer sells the home or a max time period is reached. As represented by block 995, if there is no sale by the time that a max time period is reached, the system 850 may be configured notify an appropriate person and/or automatically order an appraisal and calculate the rights and obligations of each party under the agreement based on the appraisal or other valuation.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

1. A method comprising:
determining a desired sale price for property being sold by the seller, wherein the desired sale price comprises a price at which the seller would sell the property and is at least equal to the seller's debt on the property;
determining a modified sale price for the property, wherein the modified sale price is less than the desired sale price;
storing in a tangible storage medium terms of an agreement between a buyer and the seller, wherein the terms comprise the seller selling the property to the buyer at the modified sale price at least partially in return for the buyer agreeing to provide the seller with a portion of the property's future appreciation in value;
receiving a subsequent sale price from a sale of the property by the buyer;
calculating using a processor an amount of money to be paid to the seller based at least in part on the subsequent sale price; and
storing the amount of money in a non-transitory computer readable storage medium.

2. (canceled)

3. The method of claim 1, further comprising:
determining a benefit provided to the seller by an investor; and
storing in a tangible storage medium terms of an agreement between the seller and the investor, wherein the terms comprise the investor providing the benefit to the seller at least partially in return for the seller agreeing to provide the investor with at least a portion of the seller's portion of the property's future appreciation in value.

4. The method of claim 3, further comprising:
receiving a subsequent sale price from a sale of the property by the buyer;
calculating using a processor a first amount of money to be paid to the seller based at least in part on the sale price;
calculating using a processor a second amount of money to be paid to the investor from the first amount of money based at least partially on the benefit provided to the seller by the investor; and
storing the first and second amounts of money in a non-transitory computer readable storage medium.

5. The method of claim 3, wherein the investor comprises a mortgagee for the seller's mortgage on the property, and wherein the benefit provided to the seller by the investor comprises at least temporary payment or forgiveness of a portion of the seller's mortgage obligation.

6. The method of claim 1, further comprising:
performing a valuation of the property at some predefined point in time after the selling of the property to the buyer;
calculating using a processor an amount of money to be paid to the seller based at least in part on the valuation; and
storing the amount of money in a non-transitory computer readable storage medium.

7. The method of claim 1, wherein the property comprises real estate.

8. The method of claim 1, wherein the tangible storage medium comprises a non-transitory computer-readable medium.

9. The method of claim 1, wherein the desired sale price is based at least in part on a balance of a loan obligation owed by the seller and for which the property is collateral.

10. An apparatus comprising:
a memory system comprising terms stored therein of an agreement regarding real estate, wherein the terms comprise:
a seller selling the real estate to a buyer at a price that is less than the seller's debt on the real estate and at least partially in return for the buyer agreeing to provide the seller with a portion of the real estate's future appreciation in value.

11. The apparatus of claim 10, further comprising:
a communication device configured to receive a subsequent sale price from a sale of the real estate by the buyer to a subsequent buyer; and
a processor configured to calculate an amount of money to be paid to the seller based at least in part on the subsequent sale price.

12. The apparatus of claim 10, wherein the terms further comprise:
an investor providing a benefit to the seller at least partially in return for the seller agreeing to provide the investor with at least a portion of the seller's portion of the real estate's future appreciation in value.

13. The apparatus of claim 12, further comprising:
a communication device configured to receive an indication of a subsequent sale price from a sale of the real estate by the buyer to a subsequent buyer; and
a processor configured to:
calculate first amount of money to be paid to the seller based at least in part on the sale price; and
calculate a second amount of money to be paid to the investor from the first amount of money based at least partially on the benefit provided to the seller by the investor.

14. The apparatus of claim 12, wherein the investor comprises a mortgagee for the seller's mortgage on the real estate, and wherein the benefit provided to the seller by the investor comprises at least temporary payment or forgiveness of a portion of the seller's mortgage obligation.

15. The apparatus of claim 10, further comprising:
a processor configured to:
order a valuation of the property at some predefined point in time after the selling of the property to the buyer; and
calculate an amount of money to be paid to the seller based at least in part on the valuation.

16. A computer program product comprising non-transitory computer readable medium, wherein the non-transitory computer readable medium comprises computer-executable program code stored therein, the computer-executable program code comprising:
a first executable portion configured for determining a desired sale price for property being sold by the seller, wherein the desired sale price comprises a price at which the seller would sell the property and is at least equal to the seller's debt on the property;
a second executable portion configured for determining a modified sale price for the property, wherein the modified sale price is less than the desired sale price; and
a third executable portion configured for storing in a tangible storage medium terms of an agreement between a buyer and the seller, wherein the terms comprise the seller selling the property to the buyer at the modified sale price at least partially in return for the buyer agreeing to provide the seller with a portion of the property's future appreciation in value.

17. The computer program product of claim 16, further comprising:
a fourth executable code portion configured for determining a benefit provided to the seller by an investor; and
a fifth executable code portion configured for storing in a tangible storage medium terms of an agreement between the seller and the investor, wherein the terms comprise the investor providing the benefit to the seller at least partially in return for the seller agreeing to provide the investor with at least a portion of the seller's portion of the property's future appreciation in value.

18. A method comprising:
determining a value of a residence;
determining a difference between the value of the residence and a price for which the current owner purchased the residence, wherein the price for which the current owner purchased the residence is less than the debt that a previous owner of the residence had on the residence;
using a processor to calculate a pre-defined portion of the difference between the value of the residence and the price for which the current owner purchased the residence; and
determining that at least a portion of the pre-defined portion is to be paid to the previous owner of the residence.

19. The method of claim 18, further comprising:
determining that at least a portion of the pre-defined portion is to be paid to a mortgagee for a mortgage that was held by the previous owner of the residence.

20. The method of claim 19, wherein determining that at least a portion of the pre-defined portion is to be paid to a mortgagee for a mortgage that was held by the previous owner of the residence comprises:
determining that the mortgagee is to be paid the portion of the pre-defined portion that is determined to be paid to the previous owner of the residence up to an amount of the previous owner's mortgage that was paid or forgiven by the mortgagee.

21. The method of claim 18, wherein determining the value of the residence comprises:
determining the value of the residence based at least partially on a sale of the residence by the current owner to a subsequent owner.

22. The method of claim 18, wherein determining the value of the residence comprises:
ordering an appraisal of the residence.

23. The method of claim 18, wherein using the processor to calculate the pre-defined portion of the difference between the value of the residence and the price for which the current owner purchased the residence comprises:
using the processor to calculate a predefined percentage of the difference.

24. An apparatus comprising:
a communication device for receiving a value of a residence;
a processor operatively coupled to the communication device and configured to:
determine a difference between the value of the residence and a price for which the current owner purchased the residence, wherein the price for which the current owner purchased the residence is less than the debt that a previous owner of the residence had on the residence;
calculate a pre-defined portion of the difference between the value of the residence and the price for which the current owner purchased the residence; and
determine that at least a portion of the pre-defined portion is to be paid to the previous owner of the residence.

25. The apparatus of claim 24, wherein the processor is further configured to determine that at least a portion of the pre-defined portion is to be paid to a mortgagee for a mortgage that was held by the previous owner of the residence.
